(19) United States
(12) Patent Application Publication
(10) Pub. No.: US 2023/0362110 A1
(43) Pub. Date: Nov. 9, 2023

(54) Methods and devices allowing enhanced interaction between a connected vehicle and a conversational agent

(71) Applicant: ORANGE, Issy-les-Moulineaux (FR)

(72) Inventors: Emmanuel Le Huerou, CHATILLON CEDEX (FR); François Toutain, CHATILLON CEDEX (FR)

(21) Appl. No.: 18/310,808

(22) Filed: May 2, 2023

(30) Foreign Application Priority Data
May 3, 2022 (FR) 2204200

(51) Int. Cl. H04L 51/02; G10L 15/22; G10L 13/02

(52) U.S. Cl. CPC H04L 51/02; G10L 15/22; G10L 13/02

(57) ABSTRACT

A method for processing at least one message sent by a conversational agent, the message including a plurality of data. The processing method is implemented by a processing device and includes: a step of receiving the at least one message; a step of determining at least one first datum to be vocalized and at least one second datum to be displayed, with the data being included in the plurality of data; a step of providing the at least one first datum and the at least one second datum for rendering.

### 1. FIELD OF THE DISCLOSURE

The disclosure relates to the field of telecommunications and more specifically relates to the digital services provided for a user of a vehicle.

### 2. PRIOR ART

A known standard is the GSMA “Rich Communication Suite” (RCS) standard that defines an enhanced messaging protocol, evolving from the SMS and MMS services of telecommunications operators. The current standard (Universal Profile 2), via “Application to People” (or A2P) communications, allows a conversational agent (or “chatbot”) to interact with a user. More specifically, the protocol describes a set of enhanced message formats that can be used by a conversational agent to present information and actions to the user. These graphical and/or textual formats have been designed to facilitate conversational commerce when the user is equipped with a suitable terminal, for example, a smartphone, and their attention can be fully focused on the service.

However, within a mobility context, for example, when the user is driving a vehicle, such messages are not entirely suitable. Indeed, in such a context, the user has the communication interfaces of the vehicle at their disposal, which can be substantially different from those of a smartphone/tablet.

Therefore, a requirement exists for inventing new approaches for interacting between a conversational agent and a vehicle that are adapted to the environment provided on board the vehicle (communication interfaces, ergonomics, etc.) and to the constraints associated with driving.

### 3. SUMMARY

An aspect of the present disclosure relates to a method for processing at least one message sent by a conversational agent, said message comprising a plurality of data, said processing method being implemented by a processing device and characterized in that it comprises:
a step of receiving said at least one message;
a step of determining at least one first datum to be vocalized and at least one second datum to be displayed, with said data being included in said plurality of data;
a step of providing said at least one first datum and said at least one second datum for rendering.

Advantageously, this method allows a conversational agent to interact with a user via a graphical interface but also via a voice interface.

Specifically, the method retrieves a message from a conversational agent and then processes it in order to acquire at least one datum to be vocalized and at least one datum to be visually rendered to the user. Thus, when the gaze of the user is occupied, for example, looking at the road within a driving context, the user can, via the vocalization, acquire additional information (first datum) allowing them to optimize the dialogue with the conversational agent.

It should be noted that the data contained in the message can be data to be rendered both vocally and graphically.

It also should be noted that the step of determining can include a first step of analyzing the received message (i.e., an analysis of the data included in the message, but also an analysis of the structure of the message) and then a step of determining the data contained in the message as having to be vocalized and/or displayed.

A conversational agent is understood to mean a computer dialogue automaton capable of dialoguing with a user and/or a connected object. The conversational agent generates messages intended for the user/connected object and interprets the responses sent back in order to respond to the requests/requirements of the client.

A message is understood to mean a set of data intended to be sent by a computer system. The message can be textual in the form of a data stream or of one or more files.

According to a particular embodiment of the disclosure, a method as described above is characterized in that the steps of determining and of providing are conditional upon the result of a step of detecting the type of said at least one received message.

Advantageously, this embodiment means that the entire method does not have to be implemented when the message received from the conversational agent is not suitable. For example, when the received message is in XML (Extensible Markup Language) format, the method can process the message in order to check for the presence of a particular tag indicating the type of content of the message. Thus, implementing the steps of determining and of providing is dependent on whether or not such a tag and/or its content is present.

For example, for RCS (Rich Communication Suite) type content, “rich card”, “suggested action”, “suggested reply”, “media, text”, “calendar event”, “suggested chip list”, etc., type tags can be cited.

Alternatively and/or cumulatively, the step of detecting can correspond to the detection of the extension of a received file, i.e., the extension of the message received from the conversational agent. Thus, implementing the steps of determining and of providing is dependent on the type of extension (for example, “.xml”, “.json”, “.exe”, etc.) of the received file.

According to a particular embodiment of the disclosure, a method as described above is characterized in that the step of determining comprises a step of detecting the type of said data included in said message.

Advantageously, this embodiment makes it possible to determine whether a datum is to be vocalized (first datum) and/or displayed (second datum) as a function of the nature of the datum. For example, when the message received from the conversational agent is in XML (Extensible Markup Language) format, the method can process the message in order to detect the presence of a particular tag indicating the type/nature of the datum associated with the tag. For example, for RCS type content, the “suggested replies” tag can be cited.

Alternatively and/or cumulatively, detection can occur as a function of the nature of the datum itself. For example, if the datum is an executable, the method can deduce therefrom that the datum is not a datum to be vocalized and displayed.

According to a particular embodiment of the disclosure, a method as described above is characterized in that the step of providing is followed by a step of rendering said at least one first datum and at least one second datum.

Advantageously, this embodiment allows the data determined as having to be displayed and to be vocalized to be rendered to a user. Obviously, in this case, the processing device must be capable of vocally and visually rendering the data.

According to a particular embodiment of the disclosure, a method as described above is characterized in that the step of rendering is followed by a step of acquiring at least one third datum, called response datum, from a user.

Advantageously, this embodiment allows a response to the received message to be acquired from the user. This response is acquired, for example, via a voice command and/or an event originating from an input/output peripheral such as a button, a thumbwheel, a tap on a touch screen, etc.

According to a particular embodiment of the disclosure, a method as described above is characterized in that the step of providing further comprises providing at least one fourth datum capable of being vocalized, with said fourth datum being determined as a function of said plurality of data, and in that the step of rendering further comprises rendering said fourth datum.

Advantageously, this embodiment allows the vocalization of certain data to be contextually supplemented with elements (fourth datum) generated as a function of the data that is contained in the received message. These data are, for example, “intentions” constructed as a function of the analysis of the structure of the message and/or of data previously rendered and/or to be rendered to the user by the processing device. For example, an “intention” can be a voice command that the user is likely to enunciate and that the processing method must be able to interpret.

According to a particular embodiment of the disclosure, a method as described above is characterized in that said fourth datum is determined as a function of said at least one first datum and/or of said at least one second datum.

Advantageously, this embodiment allows the vocalization of certain data to be contextually supplemented with elements (fourth datum) generated as a function of the data that is determined as having to be displayed and/or vocalized.

For example, the method can analyze the message received from the conversational agent and determine that a datum to be vocalized corresponds to the first choice from a list of choices to be rendered to the user. In this case, the method can add an element to be vocalized, such as the text “choice 1”.

The disclosure also relates to a device for processing at least one message sent by a conversational agent, said message comprising a plurality of data, characterized in that the device comprises:
a module for receiving said at least one message;
a module for determining at least one first datum to be vocalized and at least one second datum to be displayed, with said data being included in said plurality of data;
a module for providing said at least one first datum and said at least one second datum for rendering.

It should be noted that the processing device can be a distributed device. Therefore, the modules can be distributed over several machines such as terminals, servers, etc., and can communicate with each other via a communication network such as the Internet.

The disclosure also proposes a method for sending at least one item of information relating to a conversational service, said method being implemented by a conversational agent and characterized in that it comprises:
a step of creating a message comprising at least one first datum identified as having to be visually rendered and at least one second datum identified as having to be vocally rendered;
a step of sending said message to a processing device.

Advantageously, this method allows a conversational agent to generate messages that include both data identified as having to be vocally rendered and data identified as having to be visually rendered.

Thus, the method allows, in the case of a communication between a conversational agent and a vehicle, the driver to be provided with voice functionalities in addition to the visual presentation of elements proposed by the conversational agent.

The disclosure further proposes a device for sending at least one item of information relating to a conversational service, characterized in that the device comprises:
a module for creating a message comprising at least one first datum capable of being visually rendered and at least one second datum capable of being vocally rendered;
a module for sending said message to a processing device.

The term module can equally correspond to a software component and to a hardware component or a set of hardware and software components, with a software component itself corresponding to one or more computer programs or sub-programs or, more generally, to any element of a program capable of implementing a function or a set of functions as described for the relevant modules. In the same way, a hardware component corresponds to any element of a hardware assembly capable of implementing a function or a set of functions for the relevant module (integrated circuit, chip card, memory card, etc.).

The disclosure also relates to computer programs comprising instructions for implementing the above methods according to any one of the particular embodiments described above, when said programs are executed by a processor. The methods can be implemented in various ways, in particular in hardwired form or in software form. These programs can use any programming language, and can be in the form of source code, object code, or of intermediate code between source code and object code, such as in a partially compiled form, or in any other desirable form.

The disclosure also relates to a computer-readable storage or information medium containing instructions of a computer program as mentioned above. The aforementioned recording media can be any entity or device capable of storing the program. For example, the medium can include a storage medium, such as a ROM, for example a CD-ROM or a microelectronic circuit ROM, or even a magnetic recording medium, for example a hard disk. Moreover, the recording media can correspond to a transmissible medium such as an electrical or optical signal, which can be routed via an electrical or optical cable, by radio or by other means. The programs according to the disclosure particularly can be downloaded over a network such as the Internet.

Alternatively, the recording media can correspond to an integrated circuit in which a program is incorporated, with the circuit being adapted to execute or to be used to execute the method in question.

This sending device, this processing device and these computer programs have similar features and advantages to those described above in relation to the sending method and the processing method.

### 4. LIST OF FIGURES

Further exemplary features and advantages of aspects of the disclosure will become more clearly apparent from reading the following description of particular embodiments, which are provided by way of simple illustrative and non-limiting examples, and from the accompanying drawings, in which:

FIG. 1 illustrates an example of an environment for implementing a particular embodiment of the disclosure;

FIG. 2 schematically illustrates an example of the architecture of a device adapted for implementing the processing method according to a particular embodiment of the disclosure;

FIG. 3 illustrates the main steps of the processing method according to a particular embodiment of the disclosure;

FIG. 4 illustrates the main steps of the sending method according to a particular embodiment of the disclosure; and

FIG. 5 schematically illustrates an example of the architecture of a device adapted for implementing the sending method according to a particular embodiment of the disclosure.

### 5. DESCRIPTION OF ILLUSTRATIVE EMBODIMENTS

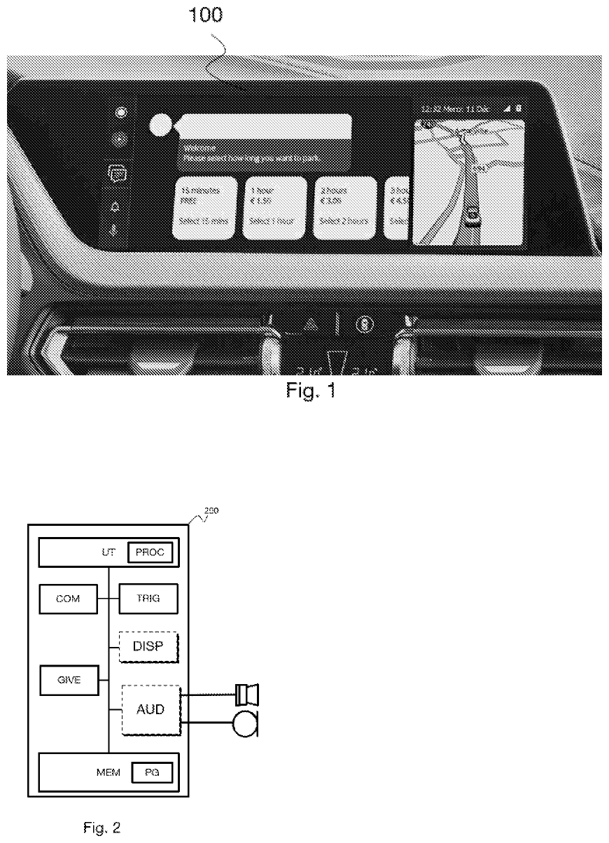

FIG. 1 illustrates an example of an environment for implementing one or more aspects of the present disclosure according to a particular embodiment. More specifically, FIG. 1 illustrates a terminal 100 capable of implementing the processing method according to a particular embodiment. It should be noted in this case that, although the terminal 100 illustrated in FIG. 1 in this case corresponds to a terminal of the “on-board computer” type of a car, aspect of the disclosure can be applied to any type of terminal having a screen and an audio module including, for example, a loudspeaker and/or a microphone, such as, for example, and in a non-limiting manner, a tablet, an electronic reader, a games console, a television, an automated teller machine, terminals/connected objects or even a personal computer.

In the example described in support of FIG. 1, the terminal 100 is an on-board car computer having a touch screen and an audio module adapted for visually and vocally interacting with a user present in the passenger compartment of the vehicle. In a conventional manner, the user of the terminal 100 can command the execution of an operation by performing an action on an area of the screen of the terminal 100. To this end, the terminal interprets the action of the user as a function of what is displayed on the screen and, more specifically, of the location where the action is performed. The action can be, for example, a tap (a brief contact made on the screen), a double tap, a long tap, a drag-and-drop, a gesture made in contact with the screen representing, for example, a signature, or any other action involving contact with the screen.

Similarly, the user can command the execution of an operation via a voice command. To this end, the terminal 100 interprets (voice recognition) the command as a function of the context and/or of the previously vocalized elements.

In the example described in support of FIG. 1, the terminal 100 communicates with a conversational agent (not shown) and acquires a message comprising data to be displayed and vocalized. The communication can be wired, for example, via PLC (Power Line Communication) when recharging the battery of the vehicle when the vehicle is an electric vehicle, or even can be wireless via, for example, Bluetooth®, Wi-Fi® and/or cellular radiotelephony technologies.

In this example, the conversational agent is a service provided by a parking manager. The conversational agent collects parking fees, for example. The data included in the message can correspond to:
an image, such as the logo of the parking management company (not shown);
a welcome text with an invitation to choose the length of stay;
a collection of possible answers that present the range of accepted durations and their associated price.

It should be noted that the message received from the conversational agent can be displayed on the vehicle screen, replacing the previous content (radio frequency, music title, road navigation map, etc.).

According to a particular embodiment, an audible signal is played/rendered in order to indicate the arrival of the message.

According to a particular embodiment, the user is only notified of the arrival of the message, and an action on their part is required in order to trigger the display.

Subsequently, the user can make their choice by using their finger to select the area of the touch screen that corresponds to their requirement or even by using a “thumbwheel” (vehicle control unit) to move around the graphical interface and select the graphical element of interest.

Cumulatively, the terminal 100 analyzes the received message in order to determine the elements to be vocalized.

FIG. 2 illustrates a device 200 configured for implementing the processing method according to a particular embodiment.

According to a particular embodiment of the disclosure, the device 200 has the conventional architecture of a computer (on-board computer of a vehicle), and particularly comprises a memory MEM, a processing unit UT, equipped with a processor PROC, for example, and controlled by the computer program PG stored in the memory MEM. The computer program PG includes instructions for implementing the steps of the processing method as described above, when the program is executed by the processor PROC.

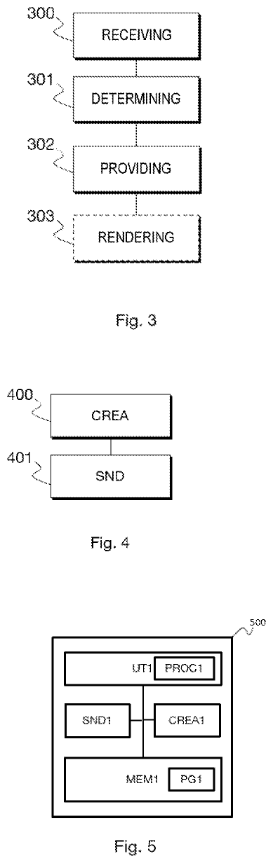

Upon initialization, the code instructions of the computer program PG are loaded, for example, into a memory before being executed by the processor PROC. In particular, the processor PROC of the processing unit UT implements the steps of the processing method according to any one of the particular embodiments described in relation to FIGS. 1 and 3, according to the instructions of the computer program PG.

The device 200 comprises a module COM configured to establish communications with a network, for example an IP network and/or a circuit. This module can be used to communicate (send and receive messages) with a conversational agent, for example when they are in close proximity.

The device 200 also comprises a module TRIG capable of determining, in a message acquired via the module COM from a conversational agent, the data to be vocalized and visually rendered to a user.

The device 200 further comprises a module GIVE capable of providing the user with the data to be vocalized and visually rendered. The provision can occur via the network. The method then sends the data to be vocalized and visually rendered to a terminal (for example, a smartphone of the user) or to a server.

According to a particular embodiment, the module GIVE and the module COM are one and the same module.

Alternatively and/or cumulatively, they can be made available locally. The device 200 can include, for example, a display module (DISP) adapted for displaying the data determined by the module TRIG as having to be visually rendered. The device can further comprise a module AUD adapted for rendering, by means of sounds, via a loudspeaker, for example, the message data determined as having to be vocalized.

According to a particular embodiment, the module AUD comprises a voice recognition module capable of interpreting voice commands enunciated by a user and detected, for example, via a microphone and then of triggering an associated action as a function of the enunciated voice command.

According to a particular embodiment, the module GIVE and the module AUD are one and the same module.

In a particular embodiment, the module GIVE and the module DISP are one and the same module.

FIG. 3 illustrates steps of the processing method according to one of the particular embodiments of the disclosure presented above, with the method being executed on the terminal 100 described in FIG. 1.

During a first step 300, the vehicle that integrates the terminal 100 enters a parking area. The method then receives a message originating from a conversational agent of a parking manager. The message includes a plurality of data to be vocalized and displayed for the attention of a user present in the passenger compartment of the vehicle.

In step 301, the message is analyzed by the method. Specifically, the method processes/scans the structure of the message (for example, an XML or JSON tree) and determines the data to be vocalized and/or displayed.

Vocalization is a known method and is most often used to respond to accessibility requirements. The disadvantage of such a method is a poor user experience, when the user undertakes to describe the whole of an electronic document including images, for example. In the case described in support of FIG. 1, the requirement is different. Indeed, it does not involve vocalizing the whole message, but determining the relevant subsets to be vocalized.

The idea is to supplement the visual presentation with a suitable description of the received message via a voice synthesis. Thus, even if the visual attention of the driver is occupied with their driving, they can still take note of the message provided by the conversational agent.

In the case of the message described in support of FIG. 1, the method can determine:
that no special processing needs to be provided regarding the logo/image, i.e., no vocalization;
that the welcome text is a datum to be vocalized and/or displayed;
that the collection/list of possible answers/choices (15 minutes (101a), one hour (101b), two hours (101c), etc.) are also data to be vocalized and/or displayed.

The method can determine the data to be vocalized and displayed as a function of the nature of the datum. For example, when the datum corresponds to text, the method can consider that the datum is to be vocalized. Similarly, if the datum is an image, the method can consider that this datum is to be displayed only.

According to a particular embodiment, the method can stop when it detects that the message is not in the correct format. Indeed, if the message is an executable message/file, the method can consider that the data included in the message is neither to be vocalized nor to be displayed.

According to a particular embodiment, the method can also add elements to be vocalized in addition to the data to be vocalized that is included in the received message. For example, when the method detects the presence of a list of choices in the message, it can add the text “please choose” or even a text “choice X”, with X being the position of the choice in the list of choices. Obviously, such elements to be vocalized are added in such a way that the rendering can be understood by the user. For example, the text “please choose” is added just before the list of choices.

According to a particular embodiment, a datum relating to a running order for the vocalization is associated with each datum and/or element to be vocalized.

The method can also determine and/or generate “intentions” as a function of the content of the message. An “intention” is a voice command that the user is likely to enunciate and that the processing method must be able to interpret. For example, when a text is vocalized, an intention is generated allowing the vocalization of the text to be repeated when requested by the user. Specifically, when the user says the “repeat” voice command (generated intention) the text is re-vocalized. In the same way, a “what are the choices?” intention can be generated by the method in order to allow vocalization of the list of choices.

It should be noted that the construction of these intentions can call upon enhanced inferences, for example, in order to take into account an enunciation such as “a quarter of an hour” as relevant for the choice of “15 minutes” (101a).

During step 302 the method provides the data determined as having to be vocalized and/or displayed. These data are then processed by a display device and a voice synthesis/recognition (step 303).

The rendering is suitably carried out so that the driver and/or the passengers can take note of the message and of the choices of suggested responses in a seamless and entirely safe manner.

Once the data has been rendered, the user is able to interact with the terminal 100 via the touch screen and/or the microphones located in the passenger compartment of the vehicle (response data within the meaning of an embodiment of the disclosure).

It should be noted that recent vehicles are generally equipped with a computer system that is often provided with voice dialogue capabilities: sound sensors effectively disposed in the passenger compartment, with a sound capture system optimized to reduce parasitic noise, a speech recognition module, a speech synthesis module, sound rendering equipment, an activation button on the steering wheel. Typically, the operating system of the vehicle uses these means to allow the user to interact with the various on-board services. The speech recognition module can be backed up by an NLP (Natural Language Processing) system capable of classifying recognized content in order to assign an intention thereto.

During step 302 the method can also provide the intentions associated with the received message. This allows the voice synthesis device/module and the speech recognition device to interact with the user more seamlessly. Indeed, as the possible actions (voice commands) of the user are already determined, they are interpreted faster.

According to a particular embodiment, the method uses a voice synthesis that is different from the one usually used in the vehicle, so that the users identify the conversational agent with a service different from those usually used on board.

According to a particular embodiment, the message received during step 300 is a structured message using a markup language (for example, XML, HTML, etc.). The message includes one or more particular tags, the associated content of which is identified as having to be vocalized.

According to a particular embodiment, the message received during step 300 is a structured message using a markup language (for example, XML, HTML, etc.). The message includes one or more particular tags, the associated content of which is identified as being one or more intentions.

In combination with the processing method, the disclosure proposes a sending method executed by a device capable of implementing a conversational agent. This device can be, for example, and in a non-limiting manner, a tablet, a connected screen, an automated teller machine, terminals/connected objects, a server and/or a computer.

FIG. 4 illustrates steps of the sending method according to a particular embodiment of the disclosure.

In step 400, the sending method generates a message including data to be vocalized and data to be displayed.

According to a particular embodiment, the message includes one or more particular tags, the associated content of which is identified as having to be vocalized and/or displayed.

According to a particular embodiment, the message includes one or more particular tags, the associated content of which is identified as being one or more intentions.

Once the message has been created, the sending method sends the message to a processing device, such as an on-board computer of a connected car.

FIG. 5 illustrates a device 500 configured for implementing the sending method according to a particular embodiment.

According to a particular embodiment of the disclosure, the device 500 has the conventional architecture of a computer (conversational agent), and particularly comprises a memory MEM1, a processing unit UT1, equipped with a processor PROC1, for example, and controlled by the computer program PG1 stored in the memory MEM1. The computer program PG1 includes instructions for implementing the steps of the processing method as described above, when the program is executed by the processor PROC1.

Upon initialization, the code instructions of the computer program PG1 are loaded, for example, into a memory before being executed by the processor PROC1. In particular, the processor PROC1 of the processing unit UT1 implements the steps of the sending method according to any one of the particular embodiments described in relation to FIGS. 1 to 4, according to the instructions of the computer program PG1.

The device 500 comprises a module CREA capable of generating messages including data to be vocalized and data to be displayed. The message uses, for example, a structured language such as XML or JSON.

The device 500 further comprises a module SND configured for establishing communications with a network, for example an IP network and/or a circuit. This module can be used to communicate with an on-board computer of a vehicle when the device is located in the vicinity thereof (sending a message generated by the module CREA to the vehicle).

It is obvious that the embodiment described above has been provided solely for indicative and non-limiting purposes, and that numerous modifications can be easily made by a person skilled in the art, yet without departing from the scope of the disclosure.

For example, aspects and embodiments of the disclosure also can be applied to a battery charging service for an electric vehicle. Specifically, when the vehicle is electrically connected to an electric recharging terminal, the conversational agent running at the terminal sends a message to the dashboard of the vehicle via PLC technology, for example. The sent message can include information to be vocalized and/or displayed, such as tariffs associated with recharging time choices, a welcome text, etc. Once the message is received by the dashboard of the vehicle, the processing method determines the information to be vocalized and the information to be visually rendered. The user present in the passenger compartment of the vehicle is thus able to choose the recharging and payment methods without having to leave the vehicle.

1. A method for processing at least one message sent by a conversational agent, said message comprising a plurality of data, said method being implemented by a processing device and comprising:
receiving said at least one message;
determining at least one first datum to be vocalized and at least one second datum to be displayed, with said data being included in said plurality of data; and
providing said at least one first datum and said at least one second datum for rendering.

2. The method according to claim 1, wherein the determining and providing are conditional upon a result of detecting a type of said at least one received message.

3. The method according to claim 1, wherein the determining comprises detecting a type of said data included in said message.

4. The method according to claim 1, wherein the providing is followed by rendering said at least one first datum and said at least one second datum.

5. The method according to claim 4, wherein the rendering is followed by acquiring at least one third datum, called response datum, from a user.

6. The method according to claim 4, wherein the providing further comprises providing at least one fourth datum capable of being vocalized, with said fourth datum being determined as a function of said plurality of data, and wherein the rendering further comprises rendering said fourth datum.

7. The method according to claim 6, wherein said fourth datum is determined as a function of said at least one first datum and/or of said at least one second datum.

8. A device for processing at least one message sent by a conversational agent, said message comprising a plurality of data, wherein the device comprises:
a processor; and
a non-transitory computer readable medium comprising instructions stored thereon which when executed by the processor configure the device to:
receive said at least one message;
determine at least one first datum to be vocalized and at least one second datum to be displayed, with said data being included in said plurality of data; and
provide said at least one first datum and said at least one second datum for rendering.

9. A non-transitory computer readable medium comprising a computer program stored thereon comprising instructions for implementing a method for processing at least one message sent by a conversational agent, when the program is executed by a processor, the message comprising a plurality of data, the method comprising:
receiving said at least one message;
determining at least one first datum to be vocalized and at least one second datum to be displayed, with said data being included in said plurality of data; and
providing said at least one first datum and said at least one second datum for rendering.
